(19) United States
(12) Patent Application Publication
(10) Pub. No.: US 2022/0400894 A1
(43) Pub. Date: Dec. 22, 2022

(54) COOKING CONTROL METHOD AND APPARATUS, COOKING DEVICE, COMPUTER READABLE STORAGE MEDIUM

(71) Applicant: FOSHAN SHUNDE MIDEA ELECTRICAL HEATING APPLIANCES MANUFACTURING CO., LTD., FOSHAN (CN)

(72) Inventors: Mengjie LIANG, FOSHAN (CN); Pengbo REN, FOSHAN (CN); Qiaoling XIAO, FOSHAN (CN)

(21) Appl. No.: 17/772,141

(22) PCT Filed: Jul. 5, 2021
(86) PCT No.: PCT/CN2021/104531

§ 371 Date: Apr. 27, 2022

(30) Foreign Application Priority Data
May 12, 2020 (CN) 202010399310.0

(51) Int. Cl. A47J 36/32; A47J 27/08; A23L 5/10

(52) U.S. Cl. CPC A47J 36/32; A47J 27/0802; A23L 5/10; A23V 2002/00

(57) ABSTRACT

Embodiments of the present application provide a cooking control method and apparatus, a cooking device, and a computer readable storage medium, being applied to cooking devices. The cooking device includes an oil draining apparatus. The cooking control method includes obtaining a cooking instruction; when it is determined that the cooking instruction instructs the initiation of an oil draining function, obtaining a first temperature inside of the cooking device; controlling, according to the first temperature and a pre-set temperature range, the working state of the cooking device, and the cooking ingredients undergo boiling periodically, and the grease inside of the cooking ingredients enters the oil draining apparatus.

### CROSS-REFERENCES TO RELATED APPLICATIONS

The present disclosure is a national phase application of International Application No. PCT/CN2021/104531, filed on Jul. 5, 2021, which claims a priority to Chinese Patent Application No. 202010399310.0, filed on May 12, 2020, the entire content of which is incorporated herein by reference.

### FIELD

The present disclosure relates to the field of cooking, but is not limited to a cooking control method, a cooking control apparatus, a cooking device and a computer-readable storage medium.

### BACKGROUND

With the improvement of life quality, people have increasing requirements for healthy diet and pay more attention to health preservation. Based on this, the requirements for cooking are also increasing. Soup is a delicious food prepared by processing vegetables, meat and other ingredients with water, milk, seasonings or the like and plays a role in promoting appetite, being a main dish, replenishing water, relieving greasy, nourishing and the like.

In the process of cooking soup, grease in ingredients will affect the taste when people drink the soup. Further, consuming too much grease is adverse for health, especially for middle-aged and elderly people with high blood sugar and high blood fat. Thus, a low-sugar and low-fat diet is increasingly needed. The existing cooking control method cannot automatically filter out the oil in the ingredients, and thus the oil in the ingredients requires to be manually filtered before having a meal, which causes inconvenience.

### SUMMARY

Embodiments of the present disclosure provide a cooking control method, a cooking control apparatus, a cooking device, and a computer-readable storage medium to solve the problems existing in the prior art.

The embodiments of the present disclosure are implemented as follows.

Embodiments of the present disclosure provide a cooking control method, applied to a cooking device including an oil draining apparatus, and the cooking control method includes:

acquiring a cooking instruction;

determining that the cooking instruction instructs initiation of an oil draining function and acquiring a first temperature in the cooking device; and

controlling, according to the first temperature and a preset temperature range, a working state of the cooking device, and cooking ingredients undergo boiling periodically and grease in the cooking ingredients enters the oil draining apparatus.

Embodiments of the present disclosure provide a cooking control apparatus, applied to a cooking device including an oil draining apparatus, and the cooking control apparatus includes:

a first acquiring module, configured to acquire a cooking instruction;

a second acquiring module, configured to determine that the cooking instruction instructs initiation of an oil draining function and acquire a first temperature in the cooking device; and

a first control module, configured to control according to the first temperature and a preset temperature range, a working state of the cooking device, and cooking ingredients undergo boiling periodically and grease in the cooking ingredients enters the oil draining apparatus.

Embodiments of the present disclosure provide a cooking device including:

an oil draining apparatus, configured to accommodate grease drained in the cooking device,

a memory, configured to store executable instructions, and

a processor, configured to when executing the executable instructions stored in the memory, performs steps of the cooking control method provided in embodiments of the present disclosure.

Embodiments of the present disclosure provide a computer-readable storage medium having stored therein executable instructions that, when executed by a processor, performs steps of the cooking control method provided in embodiments of the present disclosure.

Embodiments of the present disclosure provide a cooking control method, a cooking control apparatus, a cooking device, and a computer-readable storage medium. The cooking control method is applied to a cooking device which includes an oil draining apparatus. The cooking control method includes acquiring a cooking instruction; determining that the cooking instruction instructs initiation of an oil draining function and acquiring a first temperature in the cooking device; and controlling a working state of the cooking device according to the first temperature and a preset temperature range, and cooking ingredients undergo boiling periodically and grease in the cooking ingredients enters the oil draining apparatus. In embodiments of the present disclosure, by controlling cooking ingredients to boil periodically, the grease in the cooking ingredients is separated into the oil draining apparatus, and achieving the automatic separation of the oil in the cooking ingredients from the soup, which brings convenience for users to obtain a low-sugar and low-fat diet and meets the requirements of users on healthy cooking.

### BRIEF DESCRIPTION OF THE DRAWINGS

FIG. 1 is a flow chart showing implementation of a cooking control method provided in embodiments of the present disclosure;

FIG. 2 is a flow chart showing another implementation of a cooking control method provided in embodiments of the present disclosure;

FIG. 3 is a flow chart showing cooking parameter setting provided in embodiments of the present disclosure;

FIG. 4 is a flow chart showing another implementation of a cooking control method provided in embodiments of the present disclosure;

FIG. 5 is a schematic diagram illustrating the structure of a cooking control apparatus provided in embodiments of the present disclosure; and

FIG. 6 is a schematic diagram illustrating the structure of a cooking device provided in embodiments of the present disclosure.

### DETAILED DESCRIPTION OF THE DISCLOSURE

Embodiments of the present disclosure are described in detail below with reference to the accompanying drawings. The described embodiments should not be taken as limiting the present disclosure.

In the following description, the term “first\second\third” is merely used to distinguish similar objects and does not represent a specific ordering of objects. It is understood that where permitted, the “first\second\third” indicates that the specific order or sequence may be interchanged to enable the embodiments of the present disclosure described herein to be practiced in sequences other than those illustrated or described herein.

Unless otherwise defined, all terms used herein have the same meaning as commonly understood meaning to which the present disclosure belongs. The terms used herein are merely for the purpose of describing the embodiments of the present disclosure and are not intended to limit the present disclosure.

The cooking control method provided in embodiments of the present disclosure is described below with reference to the device provided in embodiments of the present disclosure.

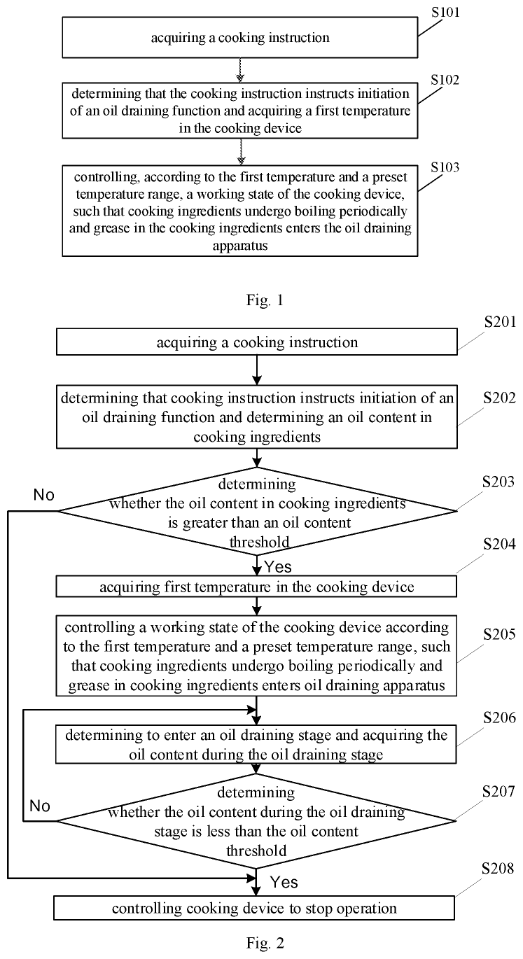

Referring to FIG. 1, FIG. 1 is a flow chart showing implementation of a cooking control method provided in embodiments of the present disclosure. The cooking control method is applied to a cooking device which includes an oil draining apparatus. The cooking device in embodiments of the present disclosure may be an electric pressure cooker, an electric rice cooker, an electric stew pot, an electric cooker, an electric steamer, a health pot, or the like. The cooking device is described in combination of the steps shown in FIG. 1.

In Step S101, a cooking instruction is acquired.

The cooking instruction herein may be an instruction triggered by a user's manual operation for controlling the cooking device. For example, the user presses a button on the cooking device, and a control apparatus of the cooking device receives the cooking instruction triggered by the user pressing the button. The cooking instruction may also be an instruction triggered by a user's voice for controlling the cooking device. For example, a control apparatus of the cooking device receives the cooking instruction triggered by the user's voice. The cooking instruction may also be an instruction triggered by an operation instruction sent by a user on a terminal. For example, the user remotely controls the terminal to send a cooking instruction, and a control apparatus of the cooking device acquires the cooking instruction through a receiving module. In practical applications, the cooking instruction may also be acquired in other possible ways, which are not limited in embodiments of the present disclosure.

In embodiments of the present disclosure, the cooking instruction may be configured to initiate a cooking process and start to cook the cooking ingredients.

In Step S102, it is determined that the cooking instruction instructs initiation of an oil draining function and a first temperature in the cooking device is acquired.

The cooking instruction instructs to initiate an oil draining function, indicating that the cooking process of the cooking device includes at least an oil draining stage. The oil draining stage will be initiated after the cooking ingredients in the cooking device reach a given temperature. Based on this, when it is determined that the cooking instruction instructs the initiation of the oil draining function, the first temperature in the cooking device is continuously monitored. When the first temperature reaches a preset temperature value, the cooking device initiates the oil draining stage.

In embodiments of the present disclosure, the first temperature in the cooking device may be acquired by a sensor deposited inside the cooking device. For example, the first temperature is acquired by a temperature sensor deposited at an upper cover of the cooking device.

In Step S103, a working state of the cooking device is controlled according to the first temperature and a preset temperature range, and cooking ingredients undergo boiling periodically and grease in the cooking ingredients enters the oil draining apparatus.

Liquids in cooking ingredients commonly include water, milk, fruit juice such as coconut juice or the like, which have a higher density than that of oil and generally incompatible with oil. Therefore, the oil in the cooking ingredients generally floats on the most upper layer. Based on this, in embodiments of the present disclosure, to filter out the oil and fat in the cooking ingredients, after the cooking ingredients are boiled, by using the boiling, the oil and fat floating on surface of the cooking ingredients enter the oil draining apparatus of the cooking device.

In embodiments of the present disclosure, the preset temperature range includes an upper limit temperature threshold and a lower limit temperature threshold. When the first temperature reaches the lower limit temperature threshold, the cooking device heats the cooking ingredients and the cooking ingredients in the cooking device begin to boil. When the first temperature reaches the upper limit temperature threshold, the cooking device stops heating and the cooking ingredients suspend to boil, and thus the grease in the cooking ingredients floats on the upper layer again. Accordingly, the heating apparatus in the cooking device is controlled to heat periodically, and the cooking ingredients undergo boiling periodically and grease in the cooking ingredients enters the oil draining apparatus at each boiling, and achieving the automatic separation of the oil in the cooking ingredients from the soup, which is convenient for the user to obtain a low-sugar and low-fat diet and meets the needs of users for healthy cooking.

In some embodiments of the present disclosure, it is determined that the cooking device enters an oil draining stage after controlling a working state of the cooking device according to the first temperature and a preset temperature range. Meanwhile, the cooking ingredients in the cooking device undergo boiling periodically and the cooking device acquires an oil draining duration during the oil draining stage. When it is determined that the oil draining duration reaches a preset threshold of oil draining duration, it is determined that the oil draining stage is ended, and the cooking device is controlled to stop operation.

Embodiments of the present disclosure provide a cooking control method, applied to a cooking device including an oil draining apparatus. The cooking control method includes acquiring a cooking instruction; determining that the cooking instruction instructs initiation of an oil draining function and acquiring a first temperature in the cooking device; and controlling, according to the first temperature and a preset temperature range, a working state of the cooking device, and cooking ingredients undergo boiling periodically and grease in the cooking ingredients enters the oil draining apparatus. According to embodiments of the present disclosure, by controlling the cooking ingredients to boil periodically, the grease in the cooking ingredients is separated into the oil draining apparatus, and achieving the automatic separation of the oil in the cooking ingredients from the soup, which brings convenience for users to obtain a low-sugar and low-fat diet and meets the requirements of users on healthy cooking.

In some embodiments of the present disclosure, the cooking instruction in the step S101 of the embodiment shown in FIG. 1 indicates that the oil draining function is initiated during the cooking process. That is, the oil draining stage is a part of the cooking process and the food obtained after cooking is a food in which oil has already been drained out. At this time, the step S102 of determining that the cooking instruction instructs initiation of an oil draining function and acquiring a first temperature in the cooking device in the embodiment shown in FIG. 1 may be realized through the steps S102a1 to S102a3. Each step is described as below.

In Step S102a1, cooking parameters are determined based on the cooking instruction acquired.

Based on the cooking instruction acquired in the step S101, the cooking parameters are determined according to the cooking instruction. In embodiments of the present disclosure, the cooking parameters include at least cooking parameters determined according to the cooking function set by the user. For example, the user presses the “soup cooking” function button on the cooking device to make a soup. The cooking parameters determined according to the preset soup cooking function in the cooking device may include a cooking time, a cooking heating method, a holding time or other parameters. In some embodiments, the cooking parameter may also be a parameter value determined according to a specific value input by the user.

In Step S102a2, the cooking device is controlled to enter a cooking process according to the cooking parameters, in which the cooking process at least includes an exhaust stage.

The control apparatus of the cooking device, according to the cooking parameters, controls the cooking device to enter the cooking process according to the cooking parameters. The cooking process at least includes an exhaust stage. For example, the cooking device starts cooking according to the heating mode set in the cooking parameters and stops the cooking after the cooking time is reached and the exhaust stage is implemented.

In embodiments of the present disclosure, the exhaust stage and the oil draining stage may be conducted in a same stage.

In Step S102a3, when it is monitored that the cooking device enters the exhaust stage, the cooking device is controlled to exhaust according to a preset exhaust cycle and the first temperature in the cooking device is acquired.

When it is monitored that the cooking process for the cooking device enters the exhaust stage from other stages such as the cooking stage, the cooking device is controlled to exhaust periodically according to the exhaust cycle. During this process, the first temperature in the cooking device is monitored.

The exhaust cycle herein may be an exhaust cycle set by the user when the cooking instruction is acquired. In one embodiment, the exhaust cycle may be a default value set in the cooking device. For example, the exhaust cycle is set to be 10:10, which means that the exhaust apparatus is periodically turned on for 10 seconds and turned off for 10 seconds.

In the cooking control method provided in embodiments of the present disclosure, the oil draining stage is set to be included in the cooking process. Thus, the user does not need to issue cooking instructions multiple times, and simplifying the user operation.

In some embodiments, the cooking instruction in the step S101 of the embodiment shown in FIG. 1 merely initiates the oil draining function. That is, the oil draining stage is implemented after the cooking has been completed. For example, the prepared soup is subjected to the oil draining. At this time, the step S102 of determining that the cooking instruction instructs initiation of an oil draining function and acquiring a first temperature in the cooking device in the embodiment shown in FIG. 1 may be realized by steps S102b1 and S102b2. Each step is described as below.

In Step S102b1, a heating apparatus in the cooking device is controlled to operate at a second power based on the cooking instruction acquired.

When the user determines that the oil needs to be drained after the user has completed the cooking or after the user has already prepared the food by using a cooking device without the oil draining apparatus, the food obtained by the cooking is placed in the cooking device including the oil draining apparatus for the oil draining. At this time, based on the cooking instruction acquired, the control apparatus of the cooking device controls the heating apparatus of the cooking device to operate at the second power.

In embodiments of the present disclosure, when the temperature in the cooking device is far lower than the lower limit temperature threshold of the preset temperature range, the second power can be set to be greater than the first power. When the temperature in the cooking device is close to the lower limit temperature threshold of the preset temperature range, the second power can be set to be equal to the first power.

In Step S102b2, the first temperature in the cooking device is acquired.

In the process of heating the cooking ingredients at the second power, the first temperature in the cooking device is acquired. When the first temperature reaches the lower limit temperature threshold of the preset temperature range, the working state of the cooking device is controlled according to the first temperature and the preset temperature range, and the cooking ingredients undergo boiling periodically and grease in the cooking ingredients enters the oil draining apparatus.

According to the cooking control method provided in embodiments of the present disclosure, the oil is drained according to the user's needs after the cooking has been completed, thus achieving the oil draining flexibly.

In some embodiments, the oil draining apparatus may be independent of the cooking device. When the oil draining is required, the oil draining apparatus is placed above the cooking ingredients. When the oil draining is not required, the oil draining apparatus does not need to be arranged. Further, when the oil draining is required, the oil draining apparatus can be placed before starting the cooking, or the oil draining apparatus can be placed after the cooking device enters the exhaust stage. In embodiments of the present disclosure, to avoid opening the top cover of the cooking device multiple times and affecting the taste of the cooking ingredients, the oil draining apparatus is selected to be placed before starting the cooking when the oil draining is required, which can also avoid the problem of not being able to drain the oil timely due to the user forgetting to place the oil draining apparatus after the cooking device enters the exhaust stage.

Based on the embodiment shown in FIG. 1, embodiments of the present disclosure further provide a cooking control method. Referring to FIG. 2, FIG. 2 is a flow chart showing another implementation of a cooking control method provided in embodiments of the present disclosure. The cooking control method is applied to a cooking device including an oil draining apparatus. The cooking control method provided in embodiments of the present disclosure includes the following steps.

In Step S201, a cooking instruction is acquired.

In embodiments of the present disclosure, the step S201 and the step S205 respectively correspond to the step S101 and the step S103 in the embodiment shown in FIG. 1. The implementation process of the step S201 and the step S205 refers to the above descriptions.

Steps S202 to S204 in embodiments of the present disclosure are a possible implementation of the step S102 in the embodiment shown in FIG. 1.

In Step S202, it is determined that the cooking instruction instructs the initiation of an oil draining function and an oil content in the cooking ingredients is determined.

When it is determined that the cooking instruction instructs to initiate the oil draining function, the cooking device determines an oil content in the cooking ingredients, and determining whether to enter the oil draining stage according to the oil content in the cooking ingredients. When the user's cooking ingredients contain little or no oil, for example, the cooking ingredient is rice, the cooking ingredient does not need to be subjected to the oil draining. At the time, even if the user turns on the oil draining function, the cooking device does not need to enter the oil draining stage. Only in the case that the cooking ingredients have a lot of oil and fat, for example, the cooking ingredient is pig trotter, and affecting the taste of food and being adverse to a healthy diet, the cooking ingredients need to be subjected to the oil draining.

In Step S203, whether the oil content in the cooking ingredients is greater than an oil content threshold is determined.

If the oil content in the cooking ingredients is greater than the preset oil content threshold, indicating that the cooking ingredients contain a lot of oil, it is confirmed that the cooking ingredients need to be subjected to the oil draining, and the step S204 is entered. If the oil content in the cooking ingredients is less than or equal to the preset oil amount threshold, indicating that the cooking ingredients contain little oil, it is confirmed that the cooking ingredients do not need to be subjected to the oil draining, and the step S208 is entered, that is the cooking device is controlled to stop operation and the cooking is ended.

The oil amount threshold may be a default value set in the cooking device in factory according to the diet habits of the public. The oil amount threshold may be a changing value set by the user according to his/her own needs, and the user can use the cooking device to flexibly cook food that is in line with his/her own eating habits.

In embodiments of the present disclosure, the oil content in the cooking ingredients is determined. When there is a lot of oil, the oil draining stage is entered for conducting the oil draining. When there is little oil, the cooking is ended. Therefore, it can avoid the extension of cooking time generated by entering the oil draining stage under a situation of little oil.

In Step S204, the first temperature in the cooking device is acquired.

In some embodiments, the cooking instruction instructs to initiate the oil draining function during the cooking process. That is, the oil draining stage is a part of the cooking process, and the food obtained by cooking is a food in which oil has been drained out. At this time, when it is determined that the oil content in the cooking ingredients is greater than the oil content threshold, namely when the oil in the cooking ingredients need to be drained, the cooking parameters are determined based on the cooking instruction acquired. The cooking device is controlled to enter the cooking process according to the cooking parameters. The cooking process at least includes an exhaust stage. When it is monitored that the cooking device enters the exhaust stage, the cooking device is controlled to exhaust according to a preset exhaust cycle, and the first temperature in the cooking device is acquired.

In some embodiments, the cooking instruction merely initiates the oil draining function. That is, the oil draining stage is implemented after the cooking is completed. For example, the prepared soup is subjected to the oil draining. At this time, when it is determined that the oil content in the cooking ingredients is greater than the oil content threshold, namely when the oil in the cooking ingredients needs to be drained, the heating apparatus in the cooking device is controlled to operate at the second power based on the cooking instruction acquired and the first temperature in the cooking device is acquired.

In Step S205, a working state of the cooking device is controlled according to the first temperature and a preset temperature range, and cooking ingredients undergo boiling periodically and grease in the cooking ingredients enters the oil draining apparatus.

In Step S206, it is determined to enter the oil draining stage and an oil content during the oil draining stage is acquired.

After the cooking device enters the oil draining stage, whether the oil draining is completed can be determined according to the oil content in the cooking ingredients during the oil draining stage. In embodiments of the present disclosure, the oil content may be detected by a detection apparatus disposed inside the cooking device, for example, the oil content in the cooking ingredients may be detected by an infrared oil detector disposed inside the cooking device.

In some embodiments, the step S206 may be replaced with the step S206a, in which the step S206a refers to determining to enter the oil draining stage and acquiring an oil draining duration during the oil draining stage. After the cooking device enters the oil draining stage, timing starts. Whether the oil draining is completed can be determined according to the oil draining duration during the oil draining stage. In embodiments of the present disclosure, the timing may be performed by a sensor disposed inside the cooking device. For example, the timing is performed by a timing sensor disposed at the bottom of the cooking device.

In some embodiments, the step S206 may be replaced with the step S206b, in which the step S206b refers to determining to enter the oil draining stage and acquiring the oil content and an oil draining duration during the oil draining stage. After the cooking device enters the oil draining stage, whether the oil draining is completed can be determined by the oil content in the cooking ingredients during the oil draining stage and the oil draining duration during the oil draining stage.

In Step S207, whether the oil content during the oil draining stage is less than an oil content threshold is determined.

In the oil draining stage, the cooking ingredients boil periodically and the grease in the cooking ingredients continuously enters the oil draining apparatus. When the oil content in the cooking ingredients is less than the preset oil threshold, it indicates that the excess grease in the cooking ingredients has been drained. At the time, the cooking ingredients have little oil and do not need to continue the oil draining. The step S208 is entered, and the cooking device is controlled to stop operation.

When the oil content during the oil draining stage is greater than or equal to the oil content threshold, the cooking ingredients are controlled to boil through continuous heating. The step S206 is returned to acquire the oil content during the oil draining stage.

In some embodiments, the step S207 may be replaced with step S207a, in which the S207a refers to determining whether the oil draining duration during the oil draining stage reaches a preset threshold of oil draining duration. When the cooking device enters the oil draining stage, the oil draining duration from the time the cooking device enters the oil draining stage is acquired by the timing of the sensor disposed inside the cooking device. When the oil draining duration reaches the preset threshold of oil draining duration, it is determined that the oil draining is ended. The step S208 is entered, and the cooking device is controlled to stop operation.

When the oil draining duration during the oil draining stage does not reach the preset threshold of oil draining duration, the cooking ingredients are controlled to boil via continuous heating. The step S206a is returned to acquire the oil draining duration during the oil draining stage.

In some embodiments, the step S207 may be replaced with step S207b, in which the step S207b refers to determining whether the oil content during the oil draining stage is less than the oil content threshold and whether the oil draining duration reaches a preset threshold of oil draining duration. In the oil draining stage, when the oil content in the cooking ingredients is less than the preset oil content threshold and the oil draining duration reaches the preset threshold of oil draining duration, it is determined that the oil draining is ended. The step S208 is entered, and the cooking device is controlled to stop operation.

When the oil content during the oil draining stage is greater than or equal to the oil content threshold or when the oil draining duration does not reach the preset threshold of oil draining duration, the cooking ingredients are controlled to boil via continuous heating. The step S206b is returned to acquire the oil content and the oil draining duration during the oil draining stage.

In Step S208, the cooking device is controlled to stop operation.

Controlling the cooking device to stop operation means that the control apparatus of the cooking device controls the heating module to stop heating. Thus, the cooking ingredient does not boil periodically again, and the grease in the cooking ingredient does not enter the oil draining apparatus. The oil draining is ended and the cooking is completed. The cooking ingredient in which the excess grease has been drained is acquired.

In embodiments of the present disclosure, the preset threshold of oil draining duration may be set by the user according to his/her own needs. The cooking instruction issued by the user includes the preset threshold of oil draining duration set by the user. According to the preset threshold of oil draining duration set based on the user's own needs, the flexibility of cooking can be increased and the food meeting the different diet habits of users can be obtained.

The preset threshold of oil draining duration may also be determined by the cooking device according to the type of the cooking ingredient. For example, the oil and fat extracted from cooking ingredients of meat is more than those extracted from cooking ingredients of vegetables. According to the cooking instruction issued by the user, when it is determined that the cooking ingredients contain a large amount of meat, such as cooking pure broth, the control apparatus in the cooking device can set a large oil draining duration threshold. According to the cooking instruction issued by the user, when it is determined that the cooking ingredients contain a little of meat, such as cooking a soup of vegetables and meat, the control apparatus in the cooking device can set a small oil draining duration threshold.

The preset threshold of oil draining duration may also be determined by the cooking device according to the cooking amount of the cooking ingredients. For example, when it is determined that there is a large cooking amount of the cooking ingredients, the control apparatus in the cooking device sets a large oil draining duration threshold. When it is determined that there is a small cooking amount of the cooking ingredients, the control apparatus in the cooking device sets a small oil draining duration threshold. The cooking amount refers to the amount of the cooking ingredients contained in a carrier for placing the cooking ingredients in the cooking device.

In embodiments of the present disclosure, the oil content in the cooking ingredients is determined. When there is a lot of oil and fat, the oil draining stage is entered for conducting the oil draining. The cooking ingredients are controlled to boil periodically, and the grease in the cooking ingredients is separated out and enters the oil draining apparatus. In the oil draining stage, at least one of the oil content in the cooking ingredients and the oil draining duration is acquired. When the oil content is less than the oil content threshold, or the oil draining duration reaches the preset threshold of oil draining duration, or the oil content is less than the oil content threshold and the oil draining duration reaches the preset threshold of oil draining duration, the cooking device is controlled to stop operation. The embodiments of the present disclosure provide various ways to control the cooking device to step operation, and users can select conditions for ending the oil draining according to their own needs, and realizing flexible oil draining.

In some embodiments, the preset temperature range includes an upper limit temperature threshold and a lower limit temperature threshold. Correspondingly, the step S103 shown in FIG. 1 or the step S205 shown in FIG. 2, namely controlling a working state of the cooking device according to the first temperature and a preset temperature range, can be implemented by the following steps.

In Step S1031, it is determined that the first temperature is greater than the upper limit temperature threshold and a heating apparatus of the cooking device is controlled to suspend operation.

In embodiments of the present disclosure, to filter out the grease in the cooking ingredients, after the cooking ingredients are boiled, by using the boiling, the grease floating on the surface of the cooking ingredients enters the oil draining apparatus of the cooking device.

In the case that the working state of the cooking device is controlled according to the first temperature and the preset temperature range, if the first temperature is greater than the upper limit temperature threshold of the preset temperature range, the cooking device stops heating the cooking ingredients, and the cooking ingredients are suspended from boiling, and the grease in the cooking ingredients floats on the upper layer.

In Step S1032, it is determined that the first temperature is less than the lower limit temperature threshold and the heating apparatus is controlled to operate at a first power.

After the cooking device stops heating, the exhaust apparatus of the cooking device exhausts to dissipate heat, and the temperature in the cooking device is reduced. When the first temperature is reduced to the lower limit temperature threshold of the preset temperature range, the cooking device heats the cooking ingredients again and the cooking ingredients in the cooking device start to boil again until the first temperature reaches the upper limit temperature threshold and thus the cooking device stops heating the cooking ingredients. The cycle is repeated, and the cooking ingredients boil periodically, and the grease in the cooking ingredients enters the oil draining apparatus until the cooking is ended.

According to the cooking control method provided in embodiments of the present disclosure, when it is determined that the first temperature is greater than the upper limit temperature threshold, the heating apparatus of the cooking device is controlled to suspend operation. When it is determined that the first temperature is lower than the lower limit temperature threshold, the heating apparatus is controlled to operate at the first power. By controlling the heating apparatus of the cooking device to heat periodically within the temperature range, the cooking ingredients are boiled periodically, and the grease in the cooking ingredients enters the oil draining apparatus until the cooking is ended.

In some embodiments, the step S1032 of controlling the heating apparatus to operate at a first power is implemented by the steps S0321 to S0323. Each step is described as below.

In Step S0321, a cooking amount of the cooking ingredients in the cooking device is acquired.

When it is monitored that the temperature in the cooking device reaches a first temperature threshold, the cooking ingredients have already had a high temperature. At this time, if the cooking ingredients are still heated at a high power, the cooking ingredients may overflow. Based on this, when the temperature in the cooking device reaches the first temperature threshold, namely when the cooking ingredients reach the first temperature threshold, a cooking amount of the cooking ingredients in the cooking device is acquired and a power adjustment ratio of the first power is determined according to the cooking amount.

In embodiments of the present disclosure, the cooking amount refers to the amount of the cooking ingredients contained in a carrier for placing the cooking ingredients in the cooking device.

In Step S0322, a cooking amount-power relationship table stored in advance is queried according to the cooking amount and the power adjustment ratio of the first power corresponding to the cooking amount is determined to be M:N.

Herein both M and N are positive numbers.

Without considering that the cooking device is affected by other external factors, the more cooking amount, the greater the power for heating. The less cooking amount, the smaller the power for heating. Therefore, a relationship table between the cooking amount and the power is established in advance and stored in a storage area of the cooking device. After the cooking amount of the cooking ingredients is acquired, the power adjustment ratio of the first power corresponding to the cooking amount is determined to be M:N by querying the cooking amount-power relationship table. The power adjustment ratio corresponding to different cooking amounts is determined to be different. When the cooking amount is large, the power adjustment ratio of the first power has a large ratio, and controlling the cooking ingredients to boil as soon as possible. When the cooking amount is small, the power adjustment ratio of the first power has a small ratio, and avoiding the cooking ingredients to boil for a long time, in which boiling for a long time prevents the oil floating on the upper layer from entering the oil draining apparatus due to the boiling.

In Step S0323, the cooking device is controlled to operate at the first power with the power adjustment ratio of M:N.

The cooking device operates at the first power with the power adjustment ratio of M:

N includes that the cooking device periodically operates at the first power for M seconds and pauses operation for N seconds.

According to the cooking amount-power relationship table stored in advance, the power adjustment ratio of the first power corresponding to the cooking amount acquired in the step S0421 is queried to be M:N. The cooking device is controlled to operate at the first power with the power adjustment ratio of M:N. That is, the cooking device is controlled to operate at the first power for M seconds, stop operation for N seconds, and then operate at the first power for M seconds and stop operation for N seconds. The cycle is repeated until the first temperature in the cooking device acquired is greater than the upper limit temperature threshold. The heating apparatus of the cooking device is controlled to stop operation.

An exemplary application of embodiments of the present disclosure in a practical application scenario is described as below.

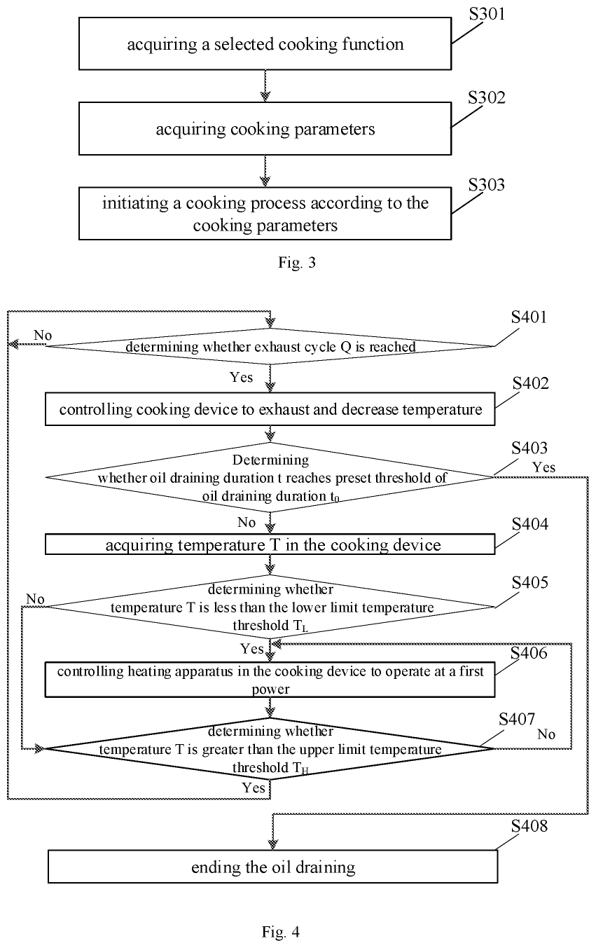

The cooking device in embodiments of the present disclosure is exemplified. FIG. 3 is a flow chart showing cooking parameter setting provided in embodiments of the present disclosure. As shown in FIG. 3, the cooking device in the embodiment of the present disclosure performs the following steps before the cooking:

In Step S301, a selected cooking function is acquired.

For example, the user selects the soup making function.

In Step S302, cooking parameters are acquired.

The cooking parameters herein may include a preset threshold of oil draining duration to, an exhaust cycle Q, or the like. The exhaust cycle Q may be set by the user for controlling the cooking device to exhaust periodically.

In embodiments of the present disclosure, the preset threshold of oil draining duration to may be 30 minutes. The exhaust cycle Q is 10:10, which means that the exhaust apparatus is periodically turned on for 10 seconds and turned off for 10 seconds.

In embodiments of the present disclosure, the cooking parameters may also include stage temperature control, namely the above preset temperature range. The stage temperature control includes an upper limit of temperature control T_{H} (i.e., the above upper limit temperature threshold) and a lower limit of temperature control T_{L} (i.e., the above lower limit temperature threshold). The temperature range includes the upper limit temperature threshold T_{H} and the lower limit temperature threshold T_{L} set for achieving indirect boiling and the oil draining. The temperature range is generally preset near the boiling point, such as the preset T_{H}=100 degrees Celsius (° C.) and the preset T_{L}=98° C. When the T_{H} and T_{L} of the temperature range are set, the altitude needs to be considered. In an area having a high altitude, if the cooking device does not have the pressurization function, T_{H} can be set to be a boiling point corresponding to the altitude of the region, and T_{L} can be set to be a temperature value slightly lower than the boiling point corresponding to the altitude of the region.

In Step S303, a cooking process is initiated according to the cooking parameters.

In embodiments of the present disclosure, during the cooking process, a sensor disposed inside the cooking device collects the temperature T in the cooking device in real time, and the sensor may be a temperature sensor disposed at the upper cover of the cooking device.

The oil draining apparatus in embodiments of the present disclosure, also referred to as the oil draining kettle, can be separated from the cooking device. When the cooking stage is ended and the oil draining is required, the oil draining apparatus is placed inside the cooking device and the oil draining is started. In one embodiment, the oil draining apparatus is placed inside the cooking device before the cooking, and the oil draining stage is directly preset to be started when the cooking stage is ended. Thus, not only the cooking time is saved, but also the oil draining effect is achieved, and improving the user experience on the product and enhancing the competitiveness of the product. Especially when the cooking device is an electric pressure cooker, the depressurization stage and the oil draining stage can be performed at the same time, which saves cooking time and improves the user experience.

FIG. 4 is a flow chart showing another implementation of a cooking control method provided in embodiments of the present disclosure. Before starting the cooking, the user puts in the cooking ingredients and the oil draining apparatus, closes the upper cover, selects the cooking function, and sets the exhaust cycle and the preset threshold of oil draining duration. After that, the cooking is initiated. In one embodiment, the user directly puts the food which has been cooked and requires the oil draining into the oil draining kettle, and then starts the oil draining program. As shown in FIG. 4, the cooking control method provided in embodiments of the present disclosure includes the following steps.

In Step S401, whether the exhaust cycle Q is reached is determined.

When the exhaust cycle is reached, air exhaust is performed and the temperature is decreased, and the process enters the step S402. When the exhaust cycle is not reached, the process returns to the step S401.

In Step S402, the cooking device is controlled to exhaust and decrease temperature.

In Step S403, whether the oil draining duration t reaches the preset threshold of oil draining duration to is determined.

When the oil draining is started, the timer disposed in the cooking device starts timing to determine whether the oil draining duration t is greater than or equal to the preset threshold of oil draining duration to. When t≥t₀, it indicates that the oil draining duration reaches the preset threshold of oil draining duration. At this time, the cooking device is controlled to end the oil draining, and thus the process enters the step S408. When t<t₀, it indicates that the oil draining duration has not yet reached the preset threshold of oil draining duration. At this time, the cooking device is controlled to continue the oil draining, and thus the process enters the step S404.

In Step S404, the temperature T in the cooking device is acquired.

In embodiments of the present disclosure, the temperature T in the cooking device may be collected through a temperature sensor disposed inside the cooking device.

In Step S405, whether the temperature T is less than the lower limit temperature threshold T_{L} is determined.

When the temperature T is less than the lower limit temperature threshold T_{L}, the cooking ingredients need to be heated, and thus the process enters the step S406. When the temperature T is greater than or equal to the lower limit temperature threshold T_{L}, whether the temperature T is greater than the upper limit temperature threshold T_{H} is further determined, and the process enters the step S407.

In Step S406, the heating apparatus in the cooking device is controlled to operate at the first power.

In some embodiments, controlling the heating apparatus in the cooking device to operate at the first power can be implemented by the following steps: acquiring the cooking amount of the cooking ingredients in the cooking device; querying the cooking amount-power relationship table stored in advance according to the cooking amount, determining the power adjustment ratio of the first power corresponding to the cooking amount to be M:N and controlling the cooking device to operate at the first power with the power adjustment ratio of M:N. Both M and N are positive numbers. The cooking device to operate at the first power with the power adjustment ratio of M:N includes that the cooking device periodically operates at the first power for M seconds and stops operation for N seconds.

In Step S407, whether the temperature T is greater than the upper limit temperature threshold T_{H} is determined.

When the temperature T in the cooking device is greater than the upper limit temperature threshold T_{H}, heating the cooking ingredients is stopped and the process returns to the step S401. When the temperature T is less than or equal to the upper limit temperature threshold T_{H}, heating is continued and the process returns to the step S406.

In Step S408, the oil draining is ended.

In the cooking control method provided in embodiments of the present disclosure, the control apparatus drives the heating apparatus to start heating, the exhaust apparatus controls the cooking device to periodically exhaust air at the exhaust cycle Q, the timing apparatus such as the timing sensor starts timing at the time the oil draining is started, and a temperature measuring apparatus such as a temperature sensor monitors the temperature T in the cooking device. In embodiments of the present disclosure, the cooking ingredients are controlled to be exhausted and boiled periodically. According to the combination of air exhaust, boiling with the oil draining apparatus, grease in the cooking ingredients is separate out and enters the oil draining apparatus via the boiling, to achieve the effect of separating the oil in cooking ingredients from the soup, which can meet the needs of users for healthy cooking and diet and improves the application value of the cooking device.

In some embodiments, the cooking control method can be integrated into any cooking program. If the oil draining is conducted in the exhaust stage after the cooking, the oil can be drained without affecting the overall cooking time to avoid prolonging the cooking time.

In some embodiments, the cooking control method can be applied to both an electric pressure cooker and a pressureless cooker such as an electric rice cooker or the like. Further, the soup can be subjected to the oil draining separately to realize the separation of the oil from the soup.

Based on the foregoing embodiments, the embodiments of the present disclosure provide a cooking control apparatus. Each unit included in the cooking control apparatus and each module included in each unit can be implemented by a processor in a computer device or can be implemented by a specific logic circuit. In the process of implementation, the processor may be a central processing unit (CPU), a microprocessor unit (MPU), a digital signal processor (DSP), a field Programmable Gate Array (FPGA) or the like.

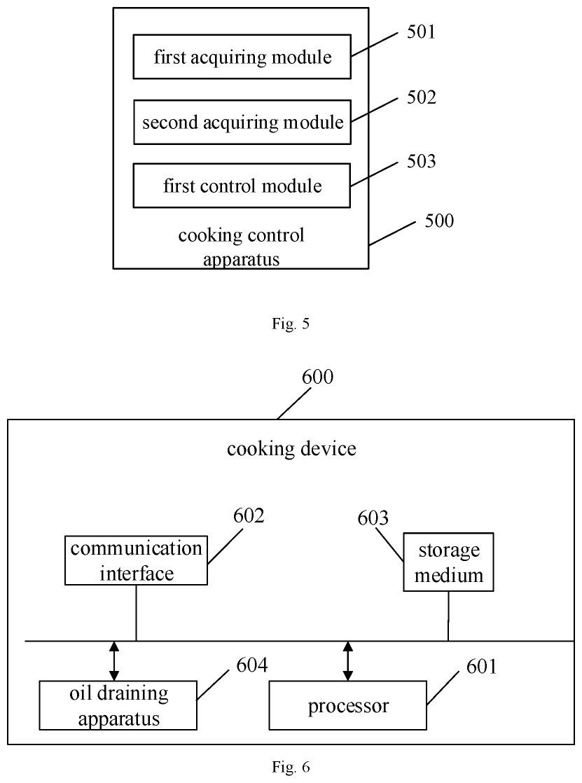

FIG. 5 is a schematic diagram illustrating the structure of a cooking control apparatus provided in embodiments of the present disclosure.

As shown in FIG. 5, the cooking control apparatus 500 may include:

a first acquiring module 501, configured to acquire a cooking instruction;

a second acquiring module 502, configured to determine that the cooking instruction instructs initiation of an oil draining function and acquire a first temperature in the cooking device; and

a first control module 503, configured to control according to the first temperature and a preset temperature range, a working state of the cooking device, and cooking ingredients undergo boiling periodically and grease in the cooking ingredients enters the oil draining apparatus.

In some embodiments, the cooking instruction instructs to initiate the oil draining function during a cooking process. Correspondingly, the second acquiring module 502 may include:

a first determining unit, configured to determine cooking parameters based on the cooking instruction acquired;

a first control unit, configured to control the cooking device to enter a cooking process according to the cooking parameters, in which the cooking process at least includes an exhaust stage;

a second control unit, configured to monitor that the cooking device enters the exhaust stage, and control the cooking device to exhaust according to a preset exhaust cycle; and

a first acquiring unit, configured to acquire the first temperature in the cooking device.

In some embodiments, the cooking instruction instructs to merely initiate the oil draining function. Correspondingly, the second acquiring module 502 may include:

a third control unit, configured to control a heating apparatus in the cooking device to operate at a second power based on the cooking instruction acquired; and

a second acquiring unit, configured to acquire the first temperature in the cooking device.

In some embodiments, the cooking control apparatus 500 further includes:

a third acquiring module, configured to determine to enter an oil draining stage and acquire an oil draining duration during the oil draining stage after controlling, according to the first temperature and a preset temperature range, a working state of the cooking device; and

a second control module, configured to determine that the oil draining duration reaches a preset threshold of oil draining duration and control the cooking device to stop operation.

The second acquiring module 502 may include:

a second determining unit, configured to determine that the cooking instruction instructs the initiation of the oil draining function and determine an oil content in the cooking ingredients, and

a third acquiring unit, configured to determine that the oil content in the cooking ingredients is greater than an oil content threshold and acquire the first temperature in the cooking device.

In some embodiments, the cooking control apparatus 500 may further include:

a fourth acquiring module, configured to determine to enter an oil draining stage and acquire the oil content during the oil draining stage after controlling, according to the first temperature and a preset temperature range, a working state of the cooking device; and

a third control module, configured to determine that the oil content during the oil draining stage is less than the oil content threshold and control the cooking device to stop operation, or

a fourth acquiring module, configured to determine to enter an oil draining stage and acquire an oil draining duration during the oil draining stage after controlling, according to the first temperature and a preset temperature range, a working state of the cooking device; and

a third control module, configured to determine that the oil draining duration during the oil draining stage reaches a preset threshold of oil draining duration and control the cooking device to stop operation, or

a fourth acquiring module, configured to determine to enter an oil draining stage and acquire the oil content and an oil draining duration during the oil draining stage after controlling, according to the first temperature and a preset temperature range, a working state of the cooking device; and

a third control module, configured to determine that the oil content during the oil draining stage is less than the oil content threshold and the oil draining duration during the oil draining stage reaches a preset threshold of oil draining duration, and control the cooking device to stop operation.

In some embodiments, the preset temperature range includes an upper limit temperature threshold and a lower limit temperature threshold.

The first control module 503 may include:

a fourth control unit, configured to determine that the first temperature is greater than the upper limit temperature threshold and control a heating apparatus of the cooking device to suspend operation; and

a fifth control unit, configured to determine that the first temperature is less than the lower limit temperature threshold and control the heating apparatus to operate at a first power.

In some embodiments, the fifth control unit may include:

an acquiring subunit, configured to acquire a cooking amount of the cooking ingredients in the cooking device;

a determining subunit, configured to query a cooking amount-power relationship table stored in advance according to the cooking amount and determine a power adjustment ratio of the first power corresponding to the cooking amount to be M:N, in which both M and N are positive numbers; and

a control subunit, configured to control the cooking device to heat the cooking ingredients at the first power with the power adjustment ratio of M:N,

In which, that the cooking device heats the cooking ingredients at the first power with the power adjustment ratio of M:N includes that the cooking device periodically heats at the first power for M seconds and pauses heating for N seconds.

It should be noted herein that the descriptions of the above embodiments for the cooking control apparatus are similar to the descriptions for the above cooking control method and have the same beneficial effects as the embodiments for the cooking control method.

It should be noted that, in embodiments of the present disclosure, if the above-mentioned cooking control method is implemented in the form of a software function module and sold or used as an independent product, the cooking control method may also be stored in a computer-readable storage medium. Based on such understanding, the embodiments of the present disclosure or the parts that make contributions to the prior art can be embodied in the form of software products in essence. The computer software products are stored in a storage medium and include several instructions for causing a computer device which may be a personal computer, a server, a network device or the like to execute all or part of the methods described in various embodiments of the present disclosure. As such, the embodiments of the present disclosure are not limited to any specific combination of hardware and software.

Correspondingly, embodiments of the present disclosure provide a cooking device. The cooking device includes an oil draining apparatus, a memory, and a processor. The oil draining apparatus is configured to accommodate the grease drained in the cooking device. The memory stores computer instructions which can be executable by a processor. When the computer instructions are executed by the processor, steps of the cooking control method provided in the above-mentioned embodiments are performed.

FIG. 6 is a schematic diagram illustrating the structure of a cooking device provided in embodiments of the present disclosure. As shown in FIG. 6, the cooking device 600 at least includes at least a processor 601, a communication interface 602, a storage medium 603 configured to store executable instructions, and an oil draining apparatus 604. The processor 601 generally controls the overall operation of the cooking device 600.

The communication interface 602 enables a path update device to communicate with other terminals or servers through a network.

The storage medium 603 is configured to store the instructions and applications which are executable by the processor 601 and can also cache the data to be processed or has been processed by each module in the processor 601 and the cooking device 600, which can be implemented by Flash Memory (FLASH) or Random Access Memory (RAM).

Correspondingly, embodiments of the present disclosure provide a computer-readable storage medium having stored therein computer instructions that, when executed by a processor, performs steps of the cooking control method provided in the above-mentioned embodiments.

It should be noted herein that the descriptions of the above embodiments for the storage medium and the cooking device are similar to the descriptions for the above cooking control method and have the same beneficial effects as the embodiments for the cooking control method. For the details not disclosed in the embodiments for the storage medium and the cooking device of the present disclosure, the descriptions of the embodiments for the cooking control method of the present disclosure to understand.

It should be understood that reference throughout the specification to “one or some embodiments” or “an embodiment” means that a particular feature, structure or characteristic associated with the embodiment is included in at least one embodiment of the present disclosure. Thus, appearances of “in one/some embodiments” or “in an embodiment” in various places throughout this specification are not necessarily referring to the same embodiment. Furthermore, the particular feature, structure or characteristic may be combined in any suitable manner in one or more embodiments. It should be understood that in various embodiments of the present disclosure, the numbers of the serial numbers in the above-mentioned processes does not mean the order of execution in which the execution order of each process should be determined by its functions and internal logic and should not construct any limitation on the implementations of the embodiments of the present disclosure. The above-mentioned serial numbers in the embodiments of the present disclosure are just for description and do not represent the advantages or disadvantages of the embodiments.

It should be noted that, herein the terms “comprising”, “including” or any other variation thereof are intended to encompass non-exclusive inclusion, and a process, method, article or device includes a series of elements includes not only those elements but also includes other elements not expressly listed, or further includes elements inherent to such a process, method, article or apparatus. Without a further limitation, an element defined by the phrase “comprising a . . . ” does not preclude the presence of additional identical elements in a process, method, article or apparatus that includes the element.

In the embodiments provided in the present disclosure, it should be understood that the disclosed device and method may be implemented in other manners. The device embodiments described above are just illustrative. For example, the division of the units is only a logical function division. In actual implementation, there may be other division methods. For example, a number of units or components may be combined or may be integrated into another system, or some features can be ignored or not implemented. In addition, the coupling, or direct coupling, or communication connection between the various components shown or discussed may be conducted through some interfaces. The indirect coupling or communication connection of devices or units may be in electrical, mechanical, or other forms.

The unit described above as a separate component may or may not be physically separated. The component displayed as a unit may or may not be a physical unit, which may be in one place or distributed to a number of network units. Some or all of the units may be selected according to actual needs to achieve the purpose of the solutions of the embodiments of the present disclosure.

In addition, each functional unit in each embodiment of the present disclosure may all be integrated into one processing unit. Each functional unit may be separately used as a unit, or two or more functional units may be integrated into one unit. The above integrated units may be implemented either in the form of hardware or in the form of hardware plus software functional units.

The above method embodiments can be performed by hardware related to program instructions. The above-mentioned program may be stored in a computer-readable storage medium. When the program is executed, the steps of the above method embodiments are executed. The above-mentioned storage medium includes various media that can store program codes, such as a U disk, a mobile hard disk, Read Only Memory (ROM), a magnetic disk, an optical disk, or the like.

In one embodiment, if the above integrated units of the present disclosure are implemented in the form of software function modules and sold or used as independent products, they may also be stored in a computer-readable storage medium. Based on such understanding, the t embodiments of the present disclosure or the parts that make contributions to the prior art can be embodied in the form of software products in essence. The computer software products are stored in a storage medium and include several instructions for causing a product to perform all or part of the methods described in the various embodiments of the present disclosure. The above-mentioned storage medium includes various media that can store program codes, such as a removable storage device, Read Only Memory (ROM), a magnetic disk, an optical disk, or the like.

The above descriptions are just the embodiments of the present disclosure, but they do not limit the protection scope of the present disclosure. Therefore, the protection scope of the present disclosure should be subject to the protection scope of the claims.

### INDUSTRIAL APPLICABILITY

Embodiments of the present disclosure provide a cooking control method and apparatus, a cooking device, and a computer readable storage medium, which are applied to a cooking device. The cooking device includes an oil draining apparatus. The cooking control method includes acquiring a cooking instruction; determining that the cooking instruction instructs initiation of an oil draining function and acquiring a first temperature in the cooking device; and controlling, according to the first temperature and a preset temperature range, a working state of the cooking device, and cooking ingredients undergo boiling periodically and grease in the cooking ingredients enters the oil draining apparatus. In embodiments of the present disclosure, by controlling the cooking ingredients to boil periodically, the grease in the cooking ingredients is separated into the oil draining apparatus, and achieving the automatic separation of the oil in the cooking ingredients from the soup, which brings convenience for users to obtain a low-sugar and low-fat diet and meets the requirements of users on healthy cooking.

1. A cooking control method, applied to a cooking device comprising,
an oil draining apparatus, wherein the cooking control method comprises:
acquiring a cooking instruction;
determining that the cooking instruction instructs initiation of an oil draining function and acquiring a first temperature in the cooking device; and
controlling, according to the first temperature and a preset temperature range, a working state of the cooking device, such that cooking ingredients undergo boiling periodically and grease in the cooking ingredients enters the oil draining apparatus.

2. The cooking control method according to claim 1, wherein the cooking instruction instructs to initiate the oil draining function during a cooking process, and correspondingly determining that the cooking instruction instructs the initiation of the oil draining function and acquiring the first temperature in the cooking device comprise:
determining cooking parameters based on the cooking instruction acquired;
controlling the cooking device to enter a cooking process according to the cooking parameters, wherein the cooking process at least comprises an exhaust stage; and
monitoring that the cooking device enters the exhaust stage, controlling the cooking device to exhaust according to a preset exhaust cycle and acquiring the first temperature in the cooking device.

3. The cooking control method according to claim 1, wherein the cooking instruction instructs to merely initiate the oil draining function, and correspondingly determining that the cooking instruction instructs the initiation of the oil draining function and acquiring the first temperature in the cooking device comprise:
controlling a heating apparatus in the cooking device to operate at a second power based on the cooking instruction acquired; and
acquiring the first temperature in the cooking device.

4. The cooking control method according to claim 1, further comprising:
determining to enter an oil draining stage and acquiring an oil draining duration during the oil draining stage after controlling, according to the first temperature and a preset temperature range, a working state of the cooking device; and
determining that the oil draining duration reaches a preset threshold of oil draining duration and controlling the cooking device to stop operation.

5. The cooking control method according to claim 1, wherein determining that the cooking instruction instructs initiation of an oil draining function and acquiring a first temperature in the cooking device comprise:
determining that the cooking instruction instructs the initiation of the oil draining function and determining an oil content in the cooking ingredients; and
determining that the oil content in the cooking ingredients is greater than an oil content threshold and acquiring the first temperature in the cooking device.

6. The cooking control method according to claim 5, further comprising:
determining to enter an oil draining stage and acquiring the oil content during the oil draining stage after controlling, according to the first temperature and a preset temperature range, a working state of the cooking device; and
determining that the oil content during the oil draining stage is less than the oil content threshold and controlling the cooking device to stop operation, or
determining to enter an oil draining stage and acquiring an oil draining duration during the oil draining stage after controlling, according to the first temperature and a preset temperature range, a working state of the cooking device; and
determining that the oil draining duration during the oil draining stage reaches a preset threshold of oil draining duration and controlling the cooking device to stop operation, or
determining to enter an oil draining stage and acquiring the oil content and an oil draining duration during the oil draining stage after controlling, according to the first temperature and a preset temperature range, a working state of the cooking device; and
determining that the oil content during the oil draining stage is less than the oil content threshold and the oil draining duration during the oil draining stage reaches a preset threshold of oil draining duration, and controlling the cooking device to stop operation.

7. The cooking control method according to claim 1, wherein the preset temperature range comprises an upper limit temperature threshold and a lower limit temperature threshold,
controlling, according to the first temperature and the preset temperature range, a working state of the cooking device comprises:
determining that the first temperature is greater than the upper limit temperature threshold and controlling a heating apparatus of the cooking device to suspend operation; and
determining that the first temperature is less than the lower limit temperature threshold and controlling the heating apparatus to operate at a first power.

8. The cooking control method according to claim 7, wherein controlling the heating apparatus to operate at a first power comprises:
acquiring a cooking amount of the cooking ingredients in the cooking device;
querying a cooking amount-power relationship table stored in advance according to the cooking amount and determining a power adjustment ratio of the first power corresponding to the cooking amount to be M:N, wherein both M and N are positive numbers; and
controlling the cooking device to heat the cooking ingredients at the first power with the power adjustment ratio of M:N,
wherein that the cooking device heats the cooking ingredients at the first power with the power adjustment ratio of M:N comprises that the cooking device periodically heats at the first power for M seconds and pauses heating for N seconds.

9. A cooking control apparatus, applied to a cooking device comprising:
an oil draining apparatus, wherein the cooking control apparatus comprises:
a first acquiring module, configured to acquire a cooking instruction;
a second acquiring module, configured to determine that the cooking instruction instructs initiation of an oil draining function and acquire a first temperature in the cooking device; and
a first control module, configured to control according to the first temperature and a preset temperature range, a working state of the cooking device, such that cooking ingredients undergo boiling periodically and grease in the cooking ingredients enters the oil draining apparatus.

10. A cooking device comprising at least:
an oil draining apparatus, configured to accommodate grease drained in the cooking device,
a memory, configured to store executable instructions, and
a processor, configured to when executing the executable instructions stored in the memory, performs steps of the cooking control method according to claim 1.

11. A computer-readable storage medium having stored therein executable instructions that, when executed by a processor, performs steps of the cooking control method according to claim 1.
